(19) United States
(12) Patent Application Publication
(10) Pub. No.: US 2015/0113314 A1
(43) Pub. Date: Apr. 23, 2015

(54) METHOD AND SYSTEM OF IMPLEMENTING A DISTRIBUTED DATABASE WITH PERIPHERAL COMPONENT INTERCONNECT EXPRESS SWITCH

(71) Applicant: BRIAN J. BULKOWSKI, Menlo Park, CA (US)

(72) Inventor: BRIAN J. BULKOWSKI, Menlo Park, CA (US)

(21) Appl. No.: 14/326,463

(22) Filed: Jul. 9, 2014

Related U.S. Application Data
(60) Provisional application No. 61/845,147, filed on Jul. 11, 2013.

(51) Int. Cl. G06F 11/20; G06F 13/40

(52) U.S. Cl. CPC G06F 11/203; G06F 13/4027; G06F 2201/80; G06F 2201/85
USPC 714/4.11

(57) ABSTRACT

In one exemplary aspect, a method a Peripheral Component Interconnect Express (PCIe) based switch that provides a bridge between a set of database nodes of the distributed database system is provided. A failure in a database node is detected. A consensus algorithm is implemented to determine a replacement database node. A database index of a data storage device formally managed by the database node that failed is migrated to a replacement database node. The PCIe-based switch is remapped to attach the replacement database node with the database index to the data storage device.

### CROSS-REFERENCE TO RELATED APPLICATIONS

This application is a claims priority to U.S. provisional patent application 61/845,147, titled METHOD AND SYSTEM OF IMPLEMENTING A DATABASE WITH PERIPHERAL COMPONENT INTERCONNECT EXPRESS FUNCTIONALITIES and filed on Jul. 11, 2013. Thus provisional application is hereby incorporated by reference in its entirety.

### BACKGROUND

1. Field

This application relates generally to data storage, and more specifically to a system, article of manufacture and method for implementing a implementing a database with peripheral component interconnect express (e.g. PCIe) functionalities.

2. Related Art

A distributed database can include a plurality of database nodes and associated data storage devices. A database node can manage a data storage device. If the database node goes offline, access to the data storage device can also go offline. Accordingly, redundancy of data can be maintained. However, maintaining data redundancy can have overhead costs and slow the speed of the database system. Additionally, offline data may need to be rebuilt (e.g. after the failure of the database node and subsequent rebalancing operations). This process can also incur a time and processing cost for the database system.

### BRIEF SUMMARY OF THE INVENTION

In one aspect, a Peripheral Component Interconnect Express (PCIe) based switch that provides a bridge between a set of database nodes of the distributed database system is provided. A failure in a database node is detected. A consensus algorithm is implemented to determine a replacement database node. A database index of a data storage device formally managed by the database node that failed is migrated to a replacement database node. The PCIe-based switch is remapped to attach the replacement database node with the database index to the data storage device.

The bridge can be provided by the PCIe based switch comprises a non-transparent bridge. The non-transparent bridge can be include a computing system on both sides of the non-transparent bridge, each with its own independent address domain. Each database node of the distributed database system uses a Linux-based operating system to implement a non-transparent bridge mode to interface with a PCIe-based entity. The consensus algorithm can be a Paxos consensus algorithm. The Paxos consensus algorithm can be implemented by a set of remaining database nodes of the distributed database system. One or more processors in each database node of the distributed database network can communicate to each through a shared memory mediated by a PCIe bus utilizing a PCIe standard. The distributed database system comprises a not only structured query language (NoSQL) distributed database system. The database nodes of the set of remaining database nodes can manage a state of the PCIe based switch.

### BRIEF DESCRIPTION OF THE DRAWINGS

The present application can be best understood by reference to the following description taken in conjunction with the accompanying figures in which like parts in be referred to by like numerals.

FIG. 1 illustrates an example distributed database system implementing a PCIe-based architecture, according to some embodiments.

FIG. 2 illustrates an example migration a database index from a locally-attached RAM of a first database node to the locally-attached RAM of a second database node, according to some embodiments.

FIG. 3 depicts an example process for implementing a database index in a distributed database with at least one PCIe switch, according to some embodiments.

FIG. 4 is a block diagram of a sample computing environment that can be utilized to implement some embodiments.

FIG. 5 shows, in a block diagram format, a distributed database system (DDBS) operating in a computer network according to an example embodiment.

The Figures described above are a representative set, and are not an exhaustive with respect to embodying the invention.

### DETAILED DESCRIPTION

Disclosed are a system, method, and article of manufacture for implementing a distributed database with a PCIe switch. The following description is presented to enable a person of ordinary skill in the art to make and use the various embodiments. Descriptions of specific devices, techniques, and applications are provided only as examples. Various modifications to the examples described herein may be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown

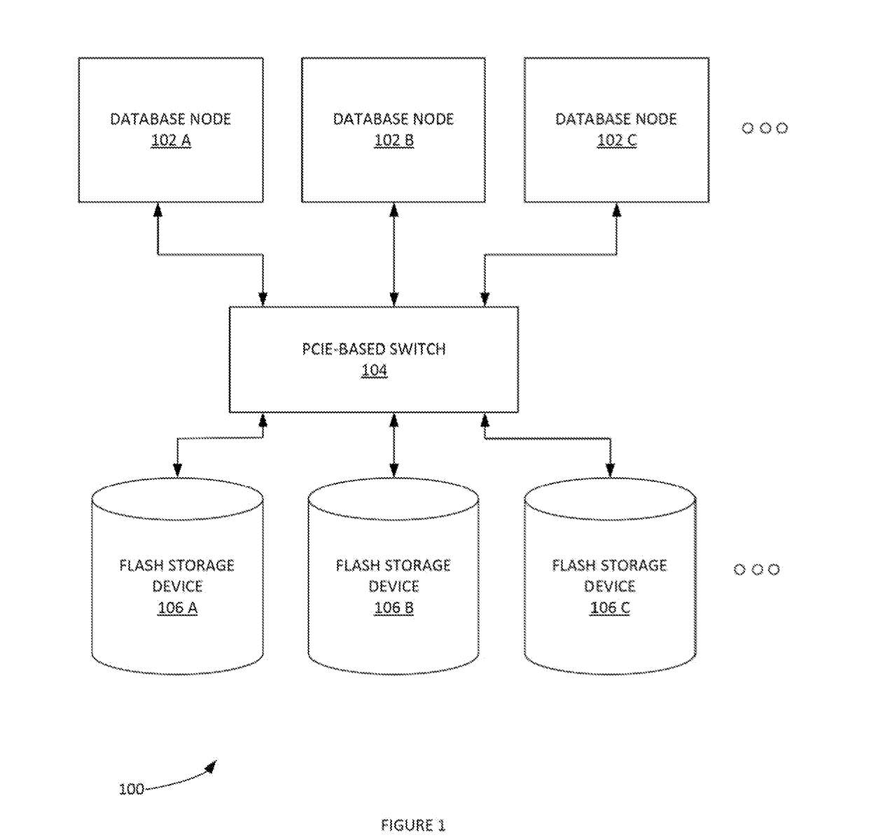

FIG. 1 illustrates an example distributed database system 1 00 implementing a Pete-based architecture, according to some embodiments. In some embodiments, distributed database system 100 can be a scalable, distributed database (e.g. a NoSQL database system) that can he synchronized across multiple data centers. Distributed database system 100 can operate using flash and solid state drives in a flash-optimized data layer (e.g. flash storage devices 106 A-C). As used herein, PCIe can be a high-speed serial computer expansion bus standard. The PCIe specification can utilize a layered architecture using a multi-gigabit per second serial interface technology. PCIe can include a protocol stack that provides transaction, data link, and physical layers. The transaction and data link Pete layers can support point-to-point communication between endpoints, end-to-end flow control, error detection, and/or a robust retransmission mechanism. The physical layer can include a high-speed serial interface (e.g. specified for 2.5 GHz operation with 8B/10B encoding and AC-coupled differential signaling). Accordingly, the PCIe standard can he used as central processing unit (CPU) to CPU (e.g. ‘chip-to-chip’, ‘board-to-board’, etc.) interconnect technology for multiple-host database communication systems. In a PCIe architecture, bridges can be used to expand the number of slots possible for the PCIe bus. Non-transparent bridging can be utilized for implementing PCIe in a multiple-host based architecture.

A self-managed distribution layer can include database nodes 102 A-C. Database nodes 102 A-C can use a Linux-based operating system (OS). The Linux-based OS can implement a non-transparent bridge mode in order to interface with a PCIe-based entity at the kernel layer. Database nodes 102 A-C can form a distributed database server cluster. A database node can manage one or more data storage devices (e.g. flash storage devices 106 A-C) in a data layer of the distributed database system 100. The data layer can he optimized to store data in solid state drives, DRAM and/or traditional rotational media. The database indices can be stored in DRAM and data writes can be optimized through large block writes to reduce latency. In one example, flash storage devices 106 A-C of the data layer can include flash-based solid state drives (SSD).

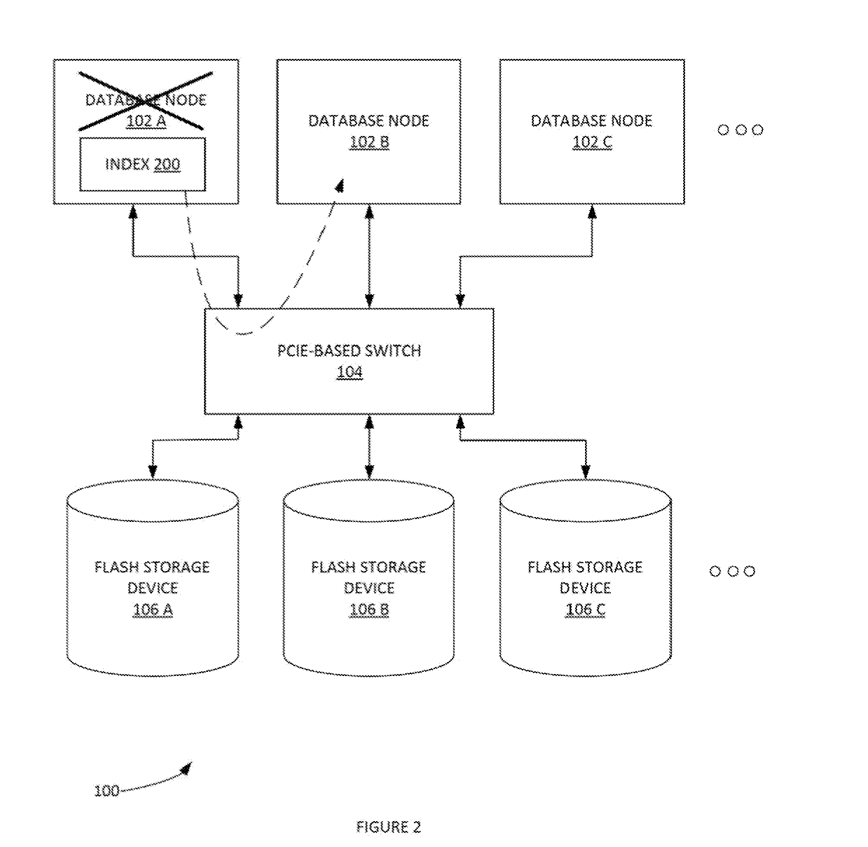

A flash-based solid state drive (SSD) can be a non-volatile storage device that stores persistent data in flash memory. The locally-attached RAM (e.g. DRAM) can, in turn, include at least one index (e.g. an index corresponding to data stored on the managed flash storage device) and/or a cache (e.g. can include a specified set of data stored in the managed flash storage device) (see FIG. 2 infra).

Database nodes 102 A-C can include a locally-attached random access memory (RAM). In some embodiments, a CPU in a database node can communicate to a CPU in another database node utilizing the PCIe standard. For example, a CPU of one database node can communicate with the CPU of another database through shared memory mediated by a PCIe bus. Furthermore, database nodes 102 A-C can communicate with PCIe-based switch 104 (e.g. a multi-port network bridge that processes and forwards data using the PCIe protocol) and/or flash storage devices 106 A-C with the PCIe standard. Furthermore, in some examples, database nodes 102 A-C can manage the state of PCIe-based switch.

PCIe-based switch 104 can implement various bridging operations (e.g. non-transparent bridging). A non-transparent bridge (e.g. Linux PCI-Express non-transparent bridge) can be functionally similar to a transparent bridge, with the exception an intelligent device and/or processor (e.g. database nodes 102 A-C) on both sides of the bridge, each with its own independent address domain. The host on one side of the bridge may not have the visibility of the complete memory or I/O space on the other side of the bridge. Each processor can consider the other side of the bridge as an endpoint and map it into its own memory space as an endpoint. PC le switch 104 can create multiple endpoints out of one endpoint to allow sharing one endpoint with multiple devices. PCIe switch 104 state can be managed by the database layer of database nodes 102 A-C. In some embodiments, one or more PCIe-based switches can form a dedicated ‘Storage Area Network (SAN)-like’ network that provides access to consolidated, block level data storage. The ‘SAN-like’ network can be used to make storage devices of data base nodes 102 A-C such that the storage devices appear like locally attached devices to a local client-side OS.

FIG. 2 illustrates an example migration a database index 200 from a locally-attached RAM of a first database node 102 A to the locally-attached RAM of a second database node 102 B, according to some embodiments. For example, a self-managed distribution layer can detect that database node 102 A has filled. The distribution layer can configure PCIe-based switch 104 to obtain database index 200. PCIe-based switch 104 can then provide index 200 to database node 102 B. Database node 102 B can attach to the stored data referenced in database index 200. For example, database node 102 B can remap PCIe-based switch 104 in order to the storage device formally managed by the offline database node 102 A. In this way, data storage associated with a data-base node can remain substantially available (e.g. assuming networking and processing; latencies associated with the migration of the database index, etc.) when a data-base node fails and/or is otherwise unavailable. In some embodiments, caches (and/or other information) in the locally-attached RAM can likewise be reconfigured in a similar manner to the replacement database node. It is noted that the other remaining database node members of the self-managed distribution layer can determine a target database node for the database index 200 by an election process. In one example, the remaining database nodes can implement a consensus-based voting process (e.g. a Paxos algorithm). A Paxos algorithm a Basic Paxos algorithm, Multi-Paxos algorithm, Cheap Paxos algorithm, Fast Paxos algorithm, Generalized Paxos algorithm, Byzantine Paxos algorithm, etc.) can include a family of protocols for solving consensus in a network of unreliable nodes. Consensus can be the process of agreeing on one result among a group of participants (e.g. database nodes in a distributed NoSQL database).

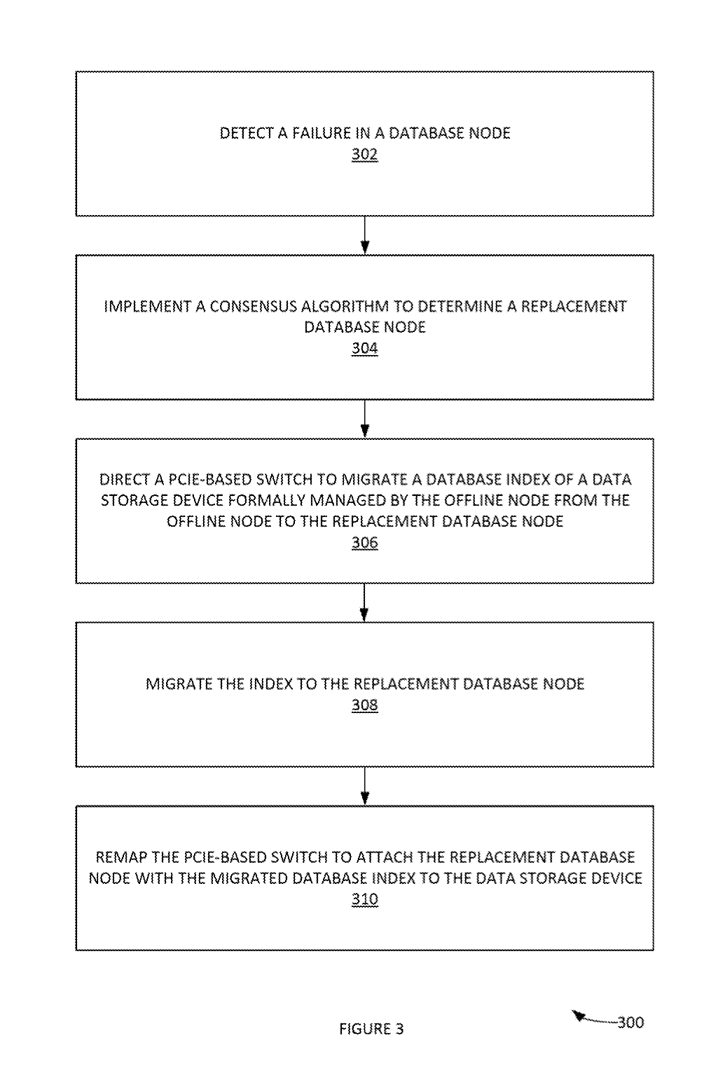

FIG. 3 depicts an example process 300 for implementing a database index in a distributed database with at least one PCIe switch, according to some embodiments. In step 302, a failure in a database node (e.g. database node 102 A of FIG. 2) is detected. A database node can include a database server with a local RAM memory that includes a database index and/or a data cache. The database node can be a part of a database cluster that include more than one database node. In step 304, the remaining database nodes of the database cluster can implement a consensus algorithm to determine a replacement database node for the offline database node. in step 306, at least one PCIe-based switch of the database cluster can be directed to pull the database index from the offline database node and migrate the database index to the replacement database node. In step 308, the database index can be migrated to the replacement database node. In step 310, the PCIe-based switch can be remapped to attach the replacement database node with the migrated database index to the data storage device formerly associated with the offline database node.

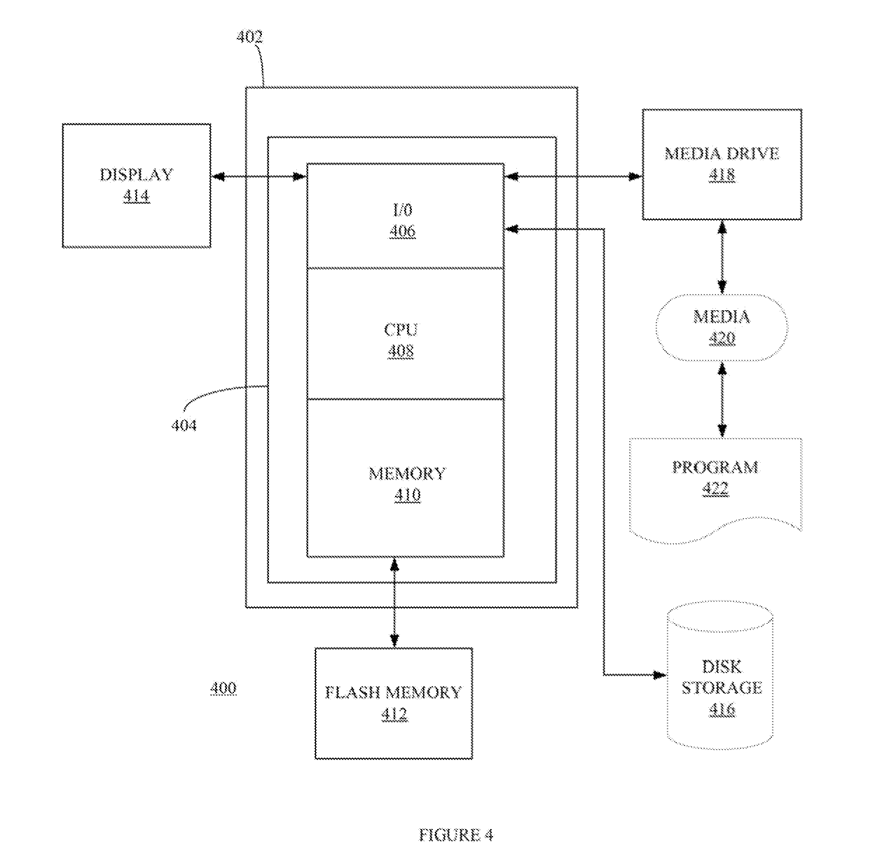

FIG. 4 depicts an exemplary computing system 400 that can be configured to perform any one of the processes provided herein. In this context, computing system 400 may include, for example, a processor, memory, storage, and IO devices e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one Of more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can include programs 422 and/or data. Computing system 400 can include a web browser. Moreover, it is noted that computing system 400 can be configured as a NoSQL distributed database server with a solid-state drive (SSD).

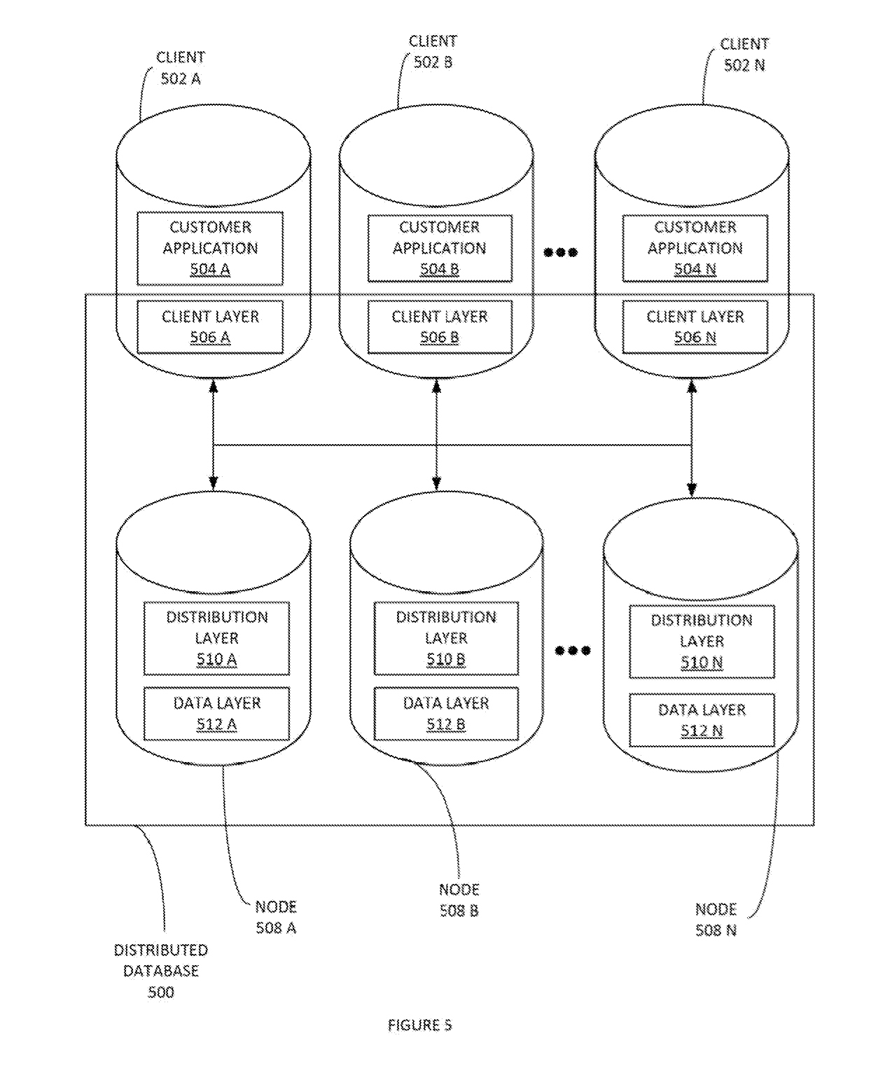

FIG. 5 shows, in a block diagram format, a distributed database system (DDBS) 500 operating in a computer network according to an example embodiment. In some examples, DDBS 500 can be an Aerospike® database. DDBS 500 can typically be a collection of databases that can be stored at different computer network sites (e.g. a server node). Each database may involve different database management systems and different architectures that distribute the execution of transactions. DDBS 500 can be managed in such a way that it appears to the user as a centralized database. It is noted that the entities of distributed database system (DDBS) 500 can be functionally connected with a PCIe interconnections (e.g. PCIe-based switches, PCIe communication standards between various machines, bridges such as non-transparent bridges, etc.). In some examples, some paths between entities can be implemented with Transmission Control Protocol (TCP), remote direct memory access (RDMA) and the like.

DDBS 500 can be a distributed, scalable NoSQL database, according to some embodiments. DDBS 500 can include, inter alia, three main layers: a client layer 506 A-N, a distribution layer 510 A-N and/or a data layer 512 A-N. Client layer 506 A-N can include various DDBS client libraries. Client layer 506 A-N can be implemented as a smart client. For example, client layer 506 A-N can implement a set of DDBS application program interfaces (APIs) that are exposed to a transaction request. Additionally, client layer 506 A-N can also track cluster configuration and manage the transaction requests, making any change in cluster membership completely transparent to customer application 504 A-N.

Distribution layer 510 A-N can be implemented as one or more server cluster nodes 508 A-N. Cluster nodes 508 A-N can communicate to ensure data consistency and replication across the cluster. Distribution layer 510 A-N can use a shared-nothing architecture. The shared-nothing architecture can be linearly scalable. Distribution layer 510 A-N can perform operations to ensure database properties that lead to the consistency and reliability of the DDBS 500. These properties can include Atomicity, Consistency, Isolation, and Durability.

Atomicity. A transaction is treated as a unit of operation. For example, in the case of a crash, the system should complete the remainder of the transaction, or it may undo all the actions pertaining to this transaction. Should a transaction fail, changes that were made to the database by it are undone (e.g. rollback).

Consistency. This property deals with maintaining consistent data in a database system. A transaction can transform the database from one consistent state to another. Consistency falls under the subject of concurrency control.

Isolation. Each transaction should carry out its work independently of any other transaction that may occur at the same time.

Durability. This property ensures that once a transaction commits, its results are permanent in the sense that the results exhibit persistence after a subsequent shutdown or failure of the database or other critical system. For example, the property of durability ensures that after a COMMIT of a transaction, whether it is a system crash or aborts of other transactions, the results that are already committed are not modified or undone.

In addition, distribution layer 510 A-N can ensure that the cluster remains fully operational when individual server nodes are removed from or added to the cluster. On each server node, a data layer 512 A-N can manage stored data on disk. Data layer 512 A-N can maintain indices corresponding to the data in the node. Furthermore, data layer 512 A-N be optimized for operational efficiency, for example, indices can be stored in a very tight format to reduce memory requirements, the system can be configured to use low level access to the physical storage media to further improve performance and the likes. It is noted, that in some embodiments, no additional cluster management servers and/or proxies need be set up and maintained other than those depicted in FIG. 5.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it may be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a nontransitory form of machine-readable medium.

What is claimed as new and desired to be protected by Letters Patent of the United States is:

1. A method of a distributed database system comprising:
providing a Peripheral Component Interconnect Express (PCIe) based switch that provides a bridge between a set of database nodes of the distributed database system;
detecting a failure in a database node;
implementing a consensus algorithm to determine a replacement database node; and
migrating, with the PCIe based switch, an index of a data storage device formally managed by the database node that failed to a replacement database node.

2. The method of claim wherein the bridge provided by the PCIe based switch comprises a non-transparent bridge.

3. The method of claim 2, wherein the non-transparent bridge comprises a computing system on both sides of the non-transparent bridge, each with its own independent address domain.

4. The method of claim 3, wherein each database node of the distributed database system uses a Linux-based operating system to implement a non-transparent bridge mode to interface with a PCIe-based entity.

5. The method of claim 1, wherein the consensus algorithm comprises a Paxos-based consensus algorithm.

6. The method of claim 5, wherein the Paxos-based consensus algorithm is implemented by by an election process performed by a set of remaining database nodes in the distributed database network.

7. The method of claim 1, wherein one or more processors in each database node of the distributed database network communicate to each through a shared memory mediated by a PCIe bus utilizing a PCIe standard.

8. The method of claim 1, wherein the distributed database system comprises a not only structured query language (NoSQL) distributed database system.

9. The method of claim 1, wherein the database nodes of the set of remaining database nodes manage a state of the PCIe based switch.

10. A computerized system comprising:
a processor configured to execute instructions;
a memory containing instructions when executed on the processor, causes the processor to perform operations that:
provide a Peripheral Component interconnect Express (PCIe) based switch that provides a bridge between a set of database nodes of the distributed database system;
detect a failure in a database node;
implement a consensus algorithm to determine a replacement database node by an election process performed by a set of remaining database nodes;
migrate a database index of a data storage device formally managed by the database node that failed to a replacement database node; and
remap the PCIe based switch to attach the replacement database node with the database index to the data storage device.

11. The computerized system of claim 10, wherein the bridge provided by the PCIe based switch comprises a non-transparent bridge.

12. The computerized system of claim 11, wherein the non-transparent bridge comprises a computing system on both sides of the non-transparent bridge, each with its own independent address domain.

13. The computerized system of claim 12, wherein each database node of the distributed database system uses a Linux-based operating system to implement a non-transparent bridge mode to interface with a PCIe-based entity.

14. The computerized system of claim 10, wherein the consensus algorithm comprises a Paxos consensus algorithm.

15. The computerized system of claim 14, wherein the Nixes consensus algorithm is implemented by the set of remaining database nodes of the distributed database system.

16. The computerized system of claim 10, wherein one or more processors in each database. node of the distributed database network communicate to each through a shared memory mediated by a PCIe bus utilizing a PCIe standard.

17. The computerized system of claim 10, wherein the distributed database system comprises a not only structured query language (NoSQL) distributed database system.

18. The computerized system of claim 10, wherein the database nodes of the set of remaining database nodes manage a state of the PCIe based switch.

19. The computerized system of claim 10, wherein a cache in the database node that failed that is stored in a locally-attached random access memory (RAM) is reconfigured the replacement database node.
